(19) United States
(12) Patent Application Publication
(10) Pub. No.: US 2022/0343925 A1
(43) Pub. Date: Oct. 27, 2022

(54) SYSTEM AND METHOD FOR ENCODING AUDIO DATA

(71) Applicant: Xandrie SA, Pantin (FR)

(72) Inventors: Loïc POILON, Pantin (FR); Pierre FROTIER DE BAGNEUX, Pantin (FR)

(21) Appl. No.: 17/238,152

(22) Filed: Apr. 22, 2021

(51) Int. Cl. G10L 19/008; G10L 19/00; G06F 16/683; G06F 16/61; H04L 9/08

(52) U.S. Cl. CPC G10L 19/008; G10L 19/0017; G06F 16/683; G06F 16/61; H04L 9/0825

(57) ABSTRACT

Methods and systems are provided for encoding audio data from an audio file, wherein the audio data comprises audio samples. Audio data is segmented from the audio file in order to obtain at least one segment. Each segment comprises a time interval of the audio data, and each segment also comprises a plurality of audio samples grouped in frames. A segment index and a description stream containing the segment index is then generated. The segment index comprises the position of the segments within the audio file. A segment stream containing the audio data of one particular segment is then generated. At least part of the audio data is encrypted during the generation of the segment stream with an encryption key.

The present invention is in the field of audio data encoding. It concerns more particularly a system and a method for encoding audio data.

In the past years, streaming services have become one of the main way people listen to music, for example through their smartphone, tablet or personal computer.

The providers of streaming services store audio files on a server, and send audio data from these files, through the Internet, to the users. The audio data is often in a degraded quality, mainly to reduce the volume of audio data. This way the audio data can be sent with a lower bandwidth usage, and most users, who do not require a very high audio quality, appreciate this advantage along with a faster delivery of the audio data, even in degraded network conditions. This also enables service providers to save on storage space, and network and computing resources.

There is today a growing number of people who require a higher audio quality, provided by lossless audio files. WAV and WMA are two lossless formats that are not suitable for streaming services, because of their high volumes. FLAC is another lossless format that has lower volumes, but it does not support DRM.

Without DRM (digital right management), the streamed audio data can be easily copied and the respect of copyrights cannot be ensured. DRM is therefore necessary for most streaming services, and there is a need for the music market to have stream encryption solutions in all formats including FLAC.

One object of the present invention is to propose a system for communicating audio data via a network in a fast and reliable way.

Another object of the present invention is to save processing power of the audio server used to send audio data to a user terminal.

Another object of the present invention is to save storage space in the database comprising audio files.

The purpose of the present invention is to respond at least in part to the above-mentioned objects by proposing a system configured to build a description stream, comprising an index of an audio file segments, and a segment stream, comprising audio data of one particular segment. For this purpose, it proposes a system comprising an audio server for communicating audio data of an audio file via a network, and a database storing said audio file, the audio server comprising: an audio server network interface for communicating with the network; an audio server database interface for communicating with said database; and an audio server processor communicatively coupled with the audio server network interface and the audio server database interface, the audio server processor further configured to cause the audio server to:
segment audio data from said audio file in order to obtain at least one segment, each segment comprising a time interval of said audio data, each segment comprising a plurality of audio samples being grouped in frames,
generate a segment index and a description stream containing said segment index, said segment index comprising the position of said segments within the audio file,
generate a segment stream containing the audio data of one particular segment, at least part of said audio data being encrypted during the generation of the segment stream with an encryption key.

Thanks to these provisions, the description stream and segment stream can be simple, light structures containing all information necessary to playback audio data from an audio file, and to rebuild the audio file, all audio data being securely encrypted to reduce copyright infringement risks. The streams can be easily generated, with low processor usage, and transferred, with low bandwidth usage. This system is particularly flexible, being compatible with any type of audio encoding format and quality, and will be compatible with future encoding formats.

According to other characteristics:
at least one primary index may be used for generating the description stream, this way the segment index and therefore the description stream can be generated faster, in some cases without accessing the audio file,
the segment index may comprise an integer representing the number of segments of audio data within the audio file, and for each segment, its length in bytes and its number of audio samples, which is a simple way to indicate the positions of every segment in the audio file,
the audio server processor may further be configured to cause the audio server to:
   segment audio data from one particular segment to obtain at least one frame, each frame comprising a plurality of audio samples,
   generate a frame index comprising the position of said frames within said particular segment, said frame index being inserted inside said segment stream,
   this way the frame index can be used to navigate finely in the audio data, for example to start playback of the audio data at a precise location,
said frame index may comprise an integer representing the number of frames of audio data within said particular segment, and for each frame, its length in bytes and its number of audio samples, which is a simple way to indicate the positions of every frame in the segment,
the audio server processor may be further configured to place an encryption key identifier corresponding to said encryption key in the description stream, so that a party receiving the description stream is able to check that it has the right decryption key and/or to request the decryption key from a key server,
the segment stream may comprise, for each frame, an initialization vector and the frames are encrypted according to a counter mode encryption method, which is a secure and efficient encryption method, particularly suitable to streaming services,
the audio file encoding format may be FLAC, which offers the advantage to allow high quality, lossless audio, in file sizes that are suitable for streaming,
said segment stream may be placed in an ISO base media file format container file, which is a standard widely compatible and efficient for streaming,
said description stream may be placed in an ISO base media file format container file, which is a standard widely compatible and efficient for streaming,
said description stream may contain at least one audio data information related to the audio file among: a sample rate, a number of bits per sample, a channel count, and a sample count, so that a party receiving the description stream may have all the needed information to play the audio data,
said system may comprise a descriptive metadata database, and the audio server processor may further be configured to cause the audio server to insert descriptive metadata from said descriptive metadata database into the description stream, which allows for a centralized management of descriptive metadata for a streaming service provider; one change concerning for example an artist can be made in one step for all concerned audio files of a collection,
said system may further comprise a user terminal, said user terminal comprising: a terminal network interface for communicating with the network, an audio player connected to a sound card and a terminal processor communicatively coupled with the terminal network interface and the audio player, said audio server processor and terminal processor may further be configured to cause the audio server and terminal to:
   send a first request for audio data of said audio file, from said user terminal to said audio server,
   following said first request, segment audio data from said audio file in order to obtain at least one segment, each segment comprising a time interval of said audio data, each segment comprising a plurality of audio samples being grouped in frames,
   generate and sending to said user terminal a description stream containing a segment index, said segment index comprising the position of said segments within the audio file,
   send a second request for audio data of one particular segment of said audio file, from said user terminal to said audio server,
   following said second request, place the audio data of said particular segment in a segment stream, generating and sending to said user terminal a segment stream containing the audio data of one particular segment, at least part of said audio data being encrypted during the generation of the segment stream with an encryption key,
   decrypt at least part of the received audio data at the user terminal, using a decryption key, and playback of decrypted audio data in said user terminal,
   this system allowing for the description stream and segment stream to be dynamically generated upon request, there is no more storage need for storing segmented audio data, and processing power usage is reduced, only audio data required from a user being segmented.
said segment stream may comprise a plurality of segment stream parts, some of the segment stream parts being generated during playback of the particular segment audio data corresponding to other segment stream parts of said segment stream; this allows for a fast service, increasing streaming service user satisfaction,
said description stream may comprise a plurality of description stream parts, and at least one description stream part is sent before all segment stream parts are generated; this allows for a fast service, increasing streaming service user satisfaction.
said system may further comprise an API server, wherein said terminal processor, audio server processor and API server are configured to:
   before sending the description stream to the user terminal, sharing a session key between an API server and the user terminal, and the decryption key is sent from the API server to the user terminal, said decryption key being encrypted with said session key,
   this way the encryption key is not available to the end user, but only to the user terminal application or browser playing the audio data, so that risks of unauthorized copies of audio data is reduced.

The present invention also concerns a method for encoding audio data from an audio file, said audio data comprising audio samples, said method comprising the following steps:
segmenting audio data from said audio file in order to obtain at least one segment, each segment comprising a time interval of said audio data, each segment comprising a plurality of audio samples being grouped in frames,
generating a segment index and a description stream containing said segment index, said segment index comprising the position of said segments within the audio file,
generating a segment stream containing the audio data of one particular segment, at least part of said audio data being encrypted during the generation of the segment stream with an encryption key.

Thanks to these provisions, the description stream and segment stream can be simple, light structures containing all information necessary to playback audio data from an audio file, and to rebuild the audio file, all audio data being securely encrypted to reduce copyright infringement risks. The streams can be easily generated, with low processor usage, and transferred, with low bandwidth usage. This system is particularly flexible, being compatible with any type of audio encoding format and quality, and will be compatible with future encoding formats.

According to other characteristics:
an encryption key identifier corresponding to said encryption key may be placed in the description stream, so that a party receiving the description stream is able to check that it has the right decryption key and/or to request the decryption key from a key server,

The present invention also concerns a method for encoding and sending audio data of an audio file from an audio server to a user terminal, said encoding being performed according to the invention, comprising the following steps:
sending a first request for audio data of said audio file, from said user terminal to said audio server,
following said first request, segmenting audio data from said audio file in order to obtain at least one segment, each segment comprising a time interval of said audio data, each segment comprising a plurality of audio samples being grouped in frames,
generating and sending to said user terminal a description stream containing a segment index, said segment index comprising the position of said segments within the audio file,
sending a second request for audio data of one particular segment of said audio file, from said user terminal to said audio server,
following said second request, placing the audio data of said particular segment in a segment stream, generating and sending to said user terminal a segment stream containing the audio data of one particular segment, at least part of said audio data being encrypted during the generation of the segment stream with an encryption key,
decryption of at least part of the received audio data by the user terminal, using a decryption key, and playback of decrypted audio data in said user terminal.

Thanks to these provisions, the description stream and segment stream may be dynamically generated upon request, there is no more storage need for storing segmented audio data, and processing power usage is reduced, only audio data required from a user being segmented.

According to other characteristics:
before sending the description stream to the user terminal, a session key is shared between an API server and the user terminal, and the decryption key is sent from the API server to the user terminal, said decryption key being encrypted with said session key; this way the encryption key is not available to the end user, but only to the user terminal application or browser playing the audio data, so that risks of unauthorized copies of audio data is reduced.

The present invention will be better understood by reading the detailed description which follows, with reference to the annexed figures in which:

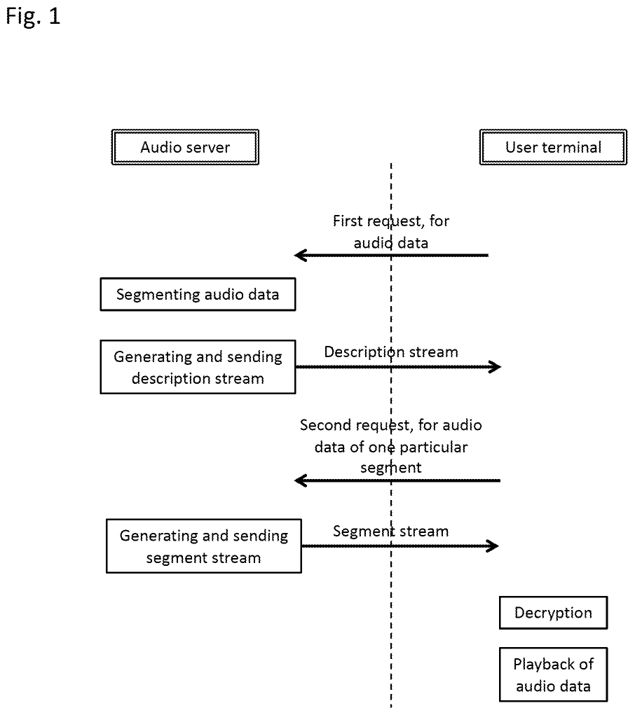

FIG. 1 is a flow chart describing a particular embodiment of a method of the present invention,

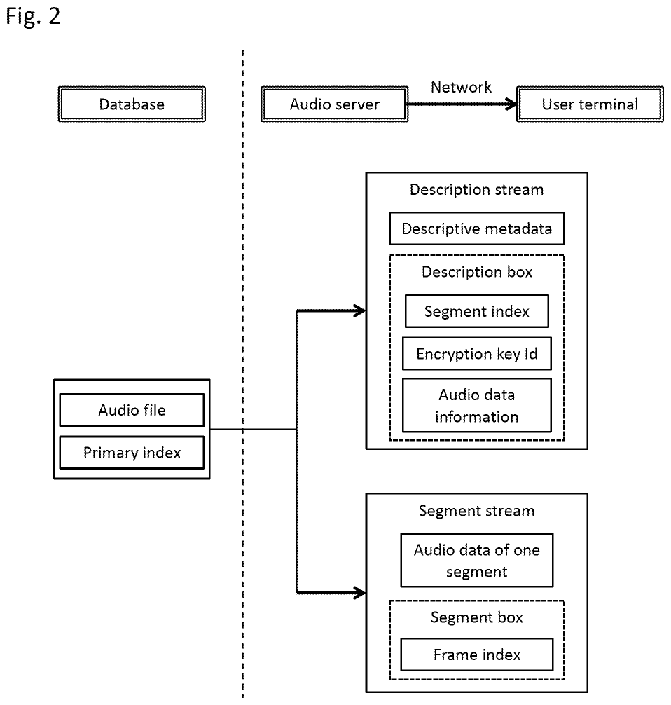

FIG. 2 is a flow chart detailing the steps of generating the description and segment streams in the method illustrated in FIG. 1.

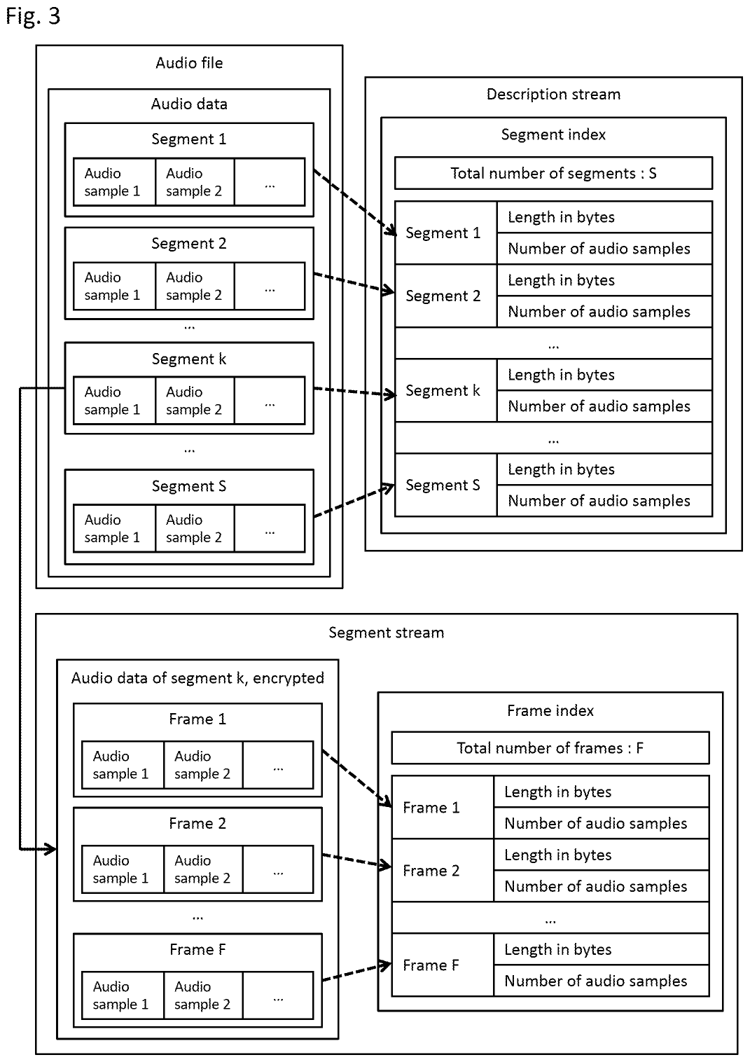

FIG. 3 shows the structure of audio data in the audio file and in the segment stream, related to the segment index in the description stream and the frame index in the segment stream, according to the method of FIG. 1.

The system according to the invention comprises an audio server for communicating audio data of an audio file via a network, and a database storing said audio file. The audio server comprises an audio server network interface for communicating with the network, an audio server database interface for communicating with said database, and an audio server processor communicatively coupled with the audio server network interface and the audio server database interface.

The audio server processor is configured to cause the audio server to perform a plurality of steps, forming a method according to the invention.

The method according to the present invention, illustrated in one embodiment in FIGS. 1 to 3, is for encoding audio data from an audio file. The audio file is usually composed of a header, followed by a plurality of audio samples.

Digital audio files comprise audio data, encoded in a particular encoding format such as for example MP3, ALAC, FLAC, WAV, WMA.

The audio data is composed of audio samples, each coded in a certain number of bits, for example 16 bits for standard quality, or 24 bits for high quality.

The audio data sample rate defines the number of audio samples per second. The sample rate is usually 44.1 kHz for standard quality. Higher sample rate allows a higher audio quality, for example 48 kHz, 88.2 kHz, 96 kHz, 176.4, or 192 kHz or higher.

Audio data may comprise a plurality of channels. The channel count is usually 2 channels for stereophonic sound, or 6 channels for 5.1 surround sound.

The quality of digital audio data is defined by a few parameters, among which the encoding format, the sample rate, the number of bits per sample, and the channel count. In the following, mentions of “audio quality” may refer to any one or some of these parameters.

In the following, a frame is a group of bit samples, typically of several ms. For instance one frame can contain 4608 samples, and last about 104 ms with a 44.1 kHz sample rate. A segment is a group of frames, for instance comprising each 96 frames of 4608 samples. With these values, a segment would last about 10.031 s.

In the method according to the invention, audio data is encoded from one audio file into at least two streams, namely a description stream and a segment stream.

In the present invention, the term “stream” refers to a certain amount of data. This data can be structured in any known way, and encapsulated in any known file format. The streams, once generated, can be stored on a memory, or sent to a network, for example to a user terminal. They can be generated and sent on the fly, for example byte by byte.

In the present invention, the term “box” refers to a structure where data may be placed. The term box may refer to an object in an object-structured file organization. In such an organization, all data is contained in objects, designated here with the term “boxes”. Boxes of the present invention may for example follow the definition of the boxes of the ISO base media file format (ISO BMFF) standard.

The description stream and/or the segment stream are preferably wrapped in container files, for example in ISO base media file format (ISO BMFF). In a preferred embodiment, the description stream and/or the segment stream comprise specific boxes that do not exist in ISO BMFF standard, namely a description box and a segment box. These specific boxes have been developed by the inventor. Standard user terminals are not able to interpret these boxes; if they receive such boxes they will ignore them, so the description and segment boxes may be placed anywhere in an ISO BMFF file.

The audio file is preferably in a lossless format, more preferably in FLAC format. In another embodiment it can be in MP3 format, for instance MP3 320 kbps.

In some cases, a primary audio file, coded in a primary encoding format, has to be converted to the encoding format that is desired for the audio file. This way the encoding format of any audio file is known. Preferably, all audio files are the results of a re-encoding. Thus all files are encoded not only in the same format, but with specific parameters so that their structure is well known.

In order to create the description stream, the audio data from the audio file is segmented into at least one segment. One segment comprises a time interval of audio data. The duration of this time interval can be the same for all segments, for instance a duration comprised between 5 and 20 seconds, preferably 10 seconds. Or the segment duration can vary for different segments. For instance there can be one specific duration for the first segment of the audio file, for example 2 seconds, and another duration for all subsequent segments, for example between 5 and 20 seconds, preferably 10 seconds. A shorter duration for the first segment can allow a faster access to the audio file for the end user, subsequent segments can be sent during playback of the first segment.

After obtaining the at least one segment, a description stream is generated containing a segment index, optionally placed in a description box. The segment index describes the position of each segment within the audio file. The segment index can comprise an integer representing the number of segments of audio data within the audio file, and optionally for each segment, its length in bytes and/or its number of audio samples.

Besides the segment index, a key identifier may be placed in the description stream, optionally in the description box. The key identifier identifies an encryption key.

The description stream may also comprise at least one data from the following list, optionally in the description box:
a track identifier, identifying a track associated with said audio file. A track is an audio content, the track identifier for instance identifies a specific song interpreted by a specific artist,
a file identifier, identifying said audio file,
the sample rate of said audio data, in samples per second,
the number of bits per sample of said audio data,
the number of audio samples within said audio file,
the size, in bytes, of the audio file header,
the audio file header,
the size, in bytes, of the key identifier.

The description stream may also comprise descriptive metadata. Descriptive metadata may comprise for example a song title, release date, track number, performing artist, covert art, musical genre. This descriptive metadata may be copied from a descriptive metadata database, optionally part of the system of the invention, to the description stream. The descriptive metadata database makes it possible to not rely on the descriptive metadata from the audio file, but on a centralized database. So any change or mistake related to descriptive metadata concerning several audio files may be done or repaired in one action, rather than requiring an action to be performed on every single audio file.

In another step of the method of the invention, for encoding audio data from an audio file, a segment stream is generated. The segment stream comprises the audio data from one particular segment, at least partially encrypted during the generation of the segment stream with an encryption key. At least 50% of the audio data may be encrypted, for instance one frame out of two being encrypted. This way, the audio quality of the encrypted file is sufficiently degraded to discourage users to listen to the audio data without decryption. If the description stream contains an encryption key identifier, the encryption key can be identified from the key identifier stored in the description stream.

Any known encryption method may be used in this invention, the man of the art may choose the most relevant one.

In a preferred embodiment, the segment stream stores, for each frame, for example in the frame index, an initialization vector. The frames are then encrypted according to a counter mode encryption method. In such a method, it is not the frames that are directly encrypted, but a counter initialized with the initialization vector. After encrypting one block of bytes the counter is changed following a rule, for instance a simple increment of one. The result of the counter encryption is then combined with the frames using a XOR operation. For decryption, the same counter is combined with the encrypted data, using a XOR operation, before it can be decrypted. The encryption method can be AES CTR, CBC or other block cipher modes, for example with a key size of 16 bytes and a block size of 16 bytes.

Besides audio data from the particular segment, the segment stream may comprise a frame index, optionally placed in a segment box. The frame index comprises the position of each frame within said particular segment. For this, the audio data from the particular segment of the audio file is first segmented into at least one frame. One frame comprises a plurality of audio samples. The number of audio samples can be the same for all frames, for instance 4608 samples. Or the number of audio samples can be different for different frames within the same segment, varying for instance from 1000 to 10000 samples. After obtaining the at least one frame, a frame index is generated to describe the position of each frame within the particular segment. The frame index can comprise an integer representing the number of frames within the segment, and optionally for each frame, its length in bytes and/or its number of audio samples.

During the creation of the segment stream, the audio data may be converted into a different audio coding format and/or into a different bit rate before it is inserted in the segment stream. This allows for the adaptation of the segment stream size, for example before being sent to a user through a network with a low bandwidth. The audio quality can also be lower if the segment stream is intended to be sent to a user without premium access. The audio data may for example be converted into MP3 at 128 kbps, 192 kbps, 256 kbps, 320 kbps, or FLAC at 1,411.200 kbps, 4,233.6 kbps, 4,608 kbps.

Besides audio data and optionally a frame index, the segment stream may also comprise at least one data from the following list, optionally in the segment box:
if a segment box format is used, the offset of the audio data, in the segment stream, from the start of the current box,
the size of the initialization vector, in bytes,
for each frame, an initialization vector,
for each frame, a flag indicating whether the frame is encrypted or not.

In order to generate the segment index and/or the frame index if it is generated, a primary index file may be used. The primary index file may be stored along with the audio file, and comprise the position of each frame within the audio file. For example the primary index file may comprise an integer representing the number of frames within the audio file, and for each frame, its length in audio samples and in bytes. The primary index file may also store all the information stored in the audio file header, optionally structured differently than in the audio file header. This way, the description stream can be generated without accessing the audio file, but only by accessing the primary index file.

In an embodiment, a partial primary index and a full primary index are generated for each audio file.

The partial primary index stores the position of groups of frames. The groups are formed of a plurality of consecutive frames whose total duration is close to a certain target, for example one second. In this example the last frame of a group is the last frame to start just before reaching a position in the audio file that is exactly a multiple of a second. Other targets can be used. For each group of frames, the partial primary index can for example store the length of the group, in bytes and in number of audio samples, and the number of frames in the group.

The full primary index stores the position of each frame. For each frame, the partial primary index can for example store the length of the frame, in bytes and in number of audio samples.

Besides this index, each of the partial and full primary indexes may comprise at least one data related to the audio file, from the following list, in their respective headers:
the header length, in bytes,
the type of primary index: partial or full,
the number of groups of frames (for the partial primary index) or frames (for the full primary index) listed in the index,
the encoding format: for instance MP3, FLAC, ALAC, AAC or WMA,
the sample rate of audio data, in samples per second,
the number of bits per sample,
the channel count,
the total number of audio samples,
the position of the first byte of audio data within the audio file,
the total audio data length in the audio file, in bytes,
the number of frames in the audio file,
a minimum number of audio samples per frame, for example 4,608 for FLAC, or 1,152 samples for MP3,
a maximum number of audio samples per frame, for example 4,608 for FLAC, or 1,152 samples for MP3,
a minimum length, in bytes, for a frame, for example 1,044 for MP3,
a maximum length, in bytes, for a frame, for example 1,045 for MP3,
Pulse-code modulation (PCM) md5 hash, only for encoding formats using this method, such as FLAC.

The primary partial index, shorter and therefore easier to use than the primary full index, may contain all the information required to generate the description stream. Time and processing power can therefore be saved. If a frame index needs to be generated, only then is it necessary to access the primary full index.

The method of encoding according to the invention may be used in a method for encoding and sending audio data from an audio server to a user terminal, optionally part of the system of the invention, comprising the following steps:
optionally, starting a shared secret session between an API server, optionally part of the system of the invention, and the user terminal, wherein the API server and the user terminal share a session key, the session key being preferably unique to every user and having a limited lifetime, for example one hour. The shared secret session may be a Diffie-Hellman key exchange, for instance using a HKDF function.
sending a first request for audio data of said audio file, from said user terminal to said audio server,
optionally, checking user rights, for instance whether the user has rights to access the audio file, and if yes, which audio quality of that file he has the right to access,
optionally, checking a catalogue, for instance whether the service provider implementing this method has the right to stream this audio file, and if yes, whether it has the right to stream it in this audio quality,
optionally, if a shared secret session has been opened, a decryption key is sent from the API server to the user terminal, said decryption key being encrypted with said session key,
following the first request, generating and sending a description stream, as described above, to the user terminal, for example by sending a Uniform Resource Locator (URL) to the user terminal where the terminal can download the description stream,
sending a second request for audio data of one particular segment of said audio file, from said user terminal to said audio server, optionally for several segments,
following the second request, placing the audio data of said particular segment in a segment stream, generating and sending to said user terminal a segment stream containing the audio data of the required particular segment. At least part of said audio data is encrypted during the generation of the segment stream with an encryption key. If the first or second request from the user terminal comprises a request for a specific audio coding format and/or a specific bit rate, and if the required format and bit rate are not available, the segment stream is encoded as instructed. The sending of the segment stream is for example done by sending a URL to the user terminal where the terminal can download the segment stream,
decryption of at least part of the received audio data by the user terminal, using the decryption key. For instance, if only part of the audio data is encrypted, only that part has to be decrypted. The decryption key and encryption key may be identical, as is the case with symmetric encryption methods such as AES.

In some embodiments, the encryption key can be sent from a key server to the user terminal. In this case, the encryption key identifier is placed in the description stream, optionally in the description box, as mentioned earlier, and the above method comprises the following steps:
sending a request for decryption key from the user terminal to a key server, said request comprising the encryption key identifier from the description stream,
sending a decryption key from said key server to said user terminal.

Placing the encryption key identifier in the description stream may be useful, even if no key server is used. If the encryption key is sent by the API server, protected by a session key, the API server may send along the encryption key identifier corresponding to the encryption key. The encryption key identifier, in this case, is not encrypted. The user terminal can then compare the two encryption key identifiers received from the API server and from the description stream, and check that the encryption keys used to encrypt the audio data and sent by the API server are the same. This is particularly useful if the user terminal tries to read audio data offline, after downloading the corresponding description and segment streams. In this case the session key, which has a limited lifetime, may have expired, and the user terminal may not have the right decryption key anymore.

The key server can replace the use of a session key, for transmitting the encryption key to the user terminal. Both may also be used in the same method. The advantage of using a session key is that the encryption key is stored on the user terminal, encrypted with the session key. This way, the user cannot access the encryption key. Only the application or the browser on the user terminal has the session key, and can decrypt the audio data after decrypting the encryption key. If the user cannot access the encryption key, the risk of unauthorized copies of audio files, infringing copyrights, is reduced.

While they are generated, parts of the segment stream and/or the description stream may be sent to the user terminal before they are complete. The segment stream, respectively description stream, may comprise a plurality of segment stream parts, respectively description stream parts, each being created successively. Once a segment stream part, respectively description part, is created, it can be sent to the user terminal before the following parts are created. The user terminal is preferably able to interpret the segment stream parts, respectively description stream parts, and process them, without having received the whole segment stream, respectively description stream. This way the user terminal can start to playback requested audio data sooner than if the whole segment stream, respectively description stream, had to be generated and transmitted before being processed at the user terminal. Thus the speed of the service is increased, which is important for streaming services users satisfaction.

Generating and sending a segment index, along with at least one segment stream, to the user terminal, allows the user terminal to reconstruct the audio data of the audio file corresponding to all the segment streams that it downloaded. The frame index and the segment index are especially useful for using a playback “seek” function, for example when a user wishes to play an audio track starting at one particular starting time, for example starting at second 34.

The present invention makes it possible to generate a segment stream in response to a user request. The segment stream may then be encoded in different audio coding formats and qualities in bits per second. The choice of the encoding type can be made according to the bandwidth available between the user terminal and the audio server, according to the user terminal specifications (browser, sound card, audio coding format compatibility), according to the user rights (for example a premium user may access to higher audio quality), or any other reason.

Creating the segment stream upon request allows the audio server to not store many versions of the same audio data, one version of the highest quality being sufficient. This reduces the streaming service provider storing needs. It can be decided to store more than one version of each audio file, for instance one high quality version of different file formats, to reduce the required processing means required for converting audio data from one format to another. Further, in case the service provider wants to add a new audio format to its service, it is not necessary to proceed to creating new copies of all its audio files into this new format. The new format can be easily added by inserting an encoding block for this format into the segment creation module. If an old format becomes rarely used, it is not necessary to maintain copies of this old format for all the audio files. Only the encoding block of this old format has to be maintained. The costs in storing and processing needs can then be reduced.

In the case where the description stream comprises a description box, containing the segment index, and optionally the encryption key identifier, these two elements will not be available to a standard user terminal receiving the description and segment streams. Without the segment index, the user terminal is not able to reconstruct the audio file. He might be able to read the audio data in the segment stream, but not to decrypt it if he needs the encryption key identifier.

In the case where the segment stream comprises a segment box, containing initialization vectors, for instance placed in the frame index, a standard user terminal will not be able to have access to the initialization vectors and might not be able to decrypt audio data from a segment stream.

This is why in a preferred embodiment, the user terminal comprises a specific application, able to interpret the description box and/or segment box, and to extract any information that may be placed in it, as described above.

Although the above description is based on particular embodiments, it is in no way limiting the scope of the invention, and modifications may be made, in particular by substitution of technical equivalents or by different combinations of all or part of the characteristics developed above.

1. A system comprising an audio server for communicating audio data of an audio file via a network, and a database storing said audio file, the audio server comprising: an audio server network interface for communicating with the network; an audio server database interface for communicating with said database; and an audio server processor communicatively coupled with the audio server network interface and the audio server database interface, the audio server processor further configured to cause the audio server to:
segment audio data from said audio file in order to obtain at least one segment, each segment comprising a time interval of said audio data, each segment comprising a plurality of audio samples being grouped in frames,
generate a segment index and a description stream containing said segment index, said segment index comprising the position of said segments within the audio file,
generate a segment stream containing the audio data of one particular segment, at least part of said audio data being encrypted during the generation of the segment stream with an encryption key.

2. A system according to claim 1, wherein at least one primary index is used for generating the description stream.

3. A system according to claim 1, wherein the segment index comprises an integer representing the number of segments of audio data within the audio file, and for each segment, its length in bytes and its number of audio samples.

4. A system according to claim 1, wherein the audio server processor is further configured to cause the audio server to:
segment audio data from one particular segment to obtain at least one frame, each frame comprising a plurality of audio samples,
generate a frame index comprising the position of said frames within said particular segment, said frame index being inserted inside said segment stream.

5. A system according to claim 4, wherein said frame index comprises an integer representing the number of frames of audio data within said particular segment, and for each frame, its length in bytes and its number of audio samples.

6. A system according to claim 1, wherein the audio server processor is further configured to place an encryption key identifier corresponding to said encryption key in the description stream.

7. A system according to claim 1, wherein the segment stream comprises, for each frame, an initialization vector and the frames are encrypted according to a counter mode encryption method.

8. A system according to claim 1, wherein the audio file encoding format is FLAC.

9. A system according to claim 4, wherein said segment stream comprises a segment box containing said frame index.

10. A system according to claim 1, wherein said description stream comprises a description box containing said segment index.

11. A system according to claim 1, wherein said description stream contains at least one audio data information related to the audio file among: a sample rate, a number of bits per sample, a channel count, and a sample count.

12. A system according to claim 1 comprising a descriptive metadata database, wherein the audio server processor is further configured to cause the audio server to insert descriptive metadata from said descriptive metadata database into the description stream.

13. A system according to claim 1 further comprising a user terminal, said user terminal comprising: a terminal network interface for communicating with the network, an audio player connected to a sound card and a terminal processor communicatively coupled with the terminal network interface and the audio player, said audio server processor and terminal processor further configured to cause the audio server and terminal to:
send a first request for audio data of said audio file, from said user terminal to said audio server,
following said first request, segment audio data from said audio file in order to obtain at least one segment, each segment comprising a time interval of said audio data, each segment comprising a plurality of audio samples being grouped in frames,
generate and sending to said user terminal a description stream containing a segment index, said segment index comprising the position of said segments within the audio file,
send a second request for audio data of one particular segment of said audio file, from said user terminal to said audio server,
following said second request, place the audio data of said particular segment in a segment stream, generating and sending to said user terminal a segment stream containing the audio data of one particular segment, at least part of said audio data being encrypted during the generation of the segment stream with an encryption key,
decrypt at least part of the received audio data at the user terminal, using a decryption key, and playback of decrypted audio data in said user terminal.

14. A system according to claim 13, wherein said segment stream comprises a plurality of segment stream parts, some of the segment stream parts are generated during playback of the particular segment audio data corresponding to other segment stream parts of said segment stream.

15. A system according to claim 13, wherein said description stream comprises a plurality of description stream parts, and at least one description stream part is sent before all segment stream parts are generated.

16. A system according to claim 13 further comprising an API server, wherein said terminal processor, audio server processor and API server are configured to:
before sending the description stream to the user terminal, sharing a session key between an API server and the user terminal, and the decryption key is sent from the API server to the user terminal, said decryption key being encrypted with said session key.

17. Method for encoding audio data from an audio file, said audio data comprising audio samples, said method comprising the following steps:
segmenting audio data from said audio file in order to obtain at least one segment, each segment comprising a time interval of said audio data, each segment comprising a plurality of audio samples being grouped in frames,
generating a segment index and a description stream containing said segment index, said segment index comprising the position of said segments within the audio file,
generating a segment stream containing the audio data of one particular segment, at least part of said audio data being encrypted during the generation of the segment stream with an encryption key.

18. Method according to claim 17, wherein an encryption key identifier corresponding to said encryption key is placed in the description stream.

19. Method for encoding and sending audio data of an audio file from an audio server to a user terminal, said encoding being performed according to the method of claim 17, comprising the following steps:
sending a first request for audio data of said audio file, from said user terminal to said audio server,
following said first request, segmenting audio data from said audio file in order to obtain at least one segment, each segment comprising a time interval of said audio data, each segment comprising a plurality of audio samples being grouped in frames,
generating and sending to said user terminal a description stream containing a segment index, said segment index comprising the position of said segments within the audio file,
sending a second request for audio data of one particular segment of said audio file, from said user terminal to said audio server,
following said second request, placing the audio data of said particular segment in a segment stream, generating and sending to said user terminal a segment stream containing the audio data of one particular segment, at least part of said audio data being encrypted during the generation of the segment stream with an encryption key,
decryption of at least part of the received audio data by the user terminal, using a decryption key, and playback of decrypted audio data in said user terminal.

20. Method according to claim 19, wherein before sending the description stream to the user terminal, a session key is shared between an API server and the user terminal, and the decryption key is sent from the API server to the user terminal, said decryption key being encrypted with said session key.
